(19) United States
(12) Patent Application Publication
(10) Pub. No.: US 2019/0177947 A1
(43) Pub. Date: Jun. 13, 2019

(54) IMPLEMENT ADJUSTMENT ASSEMBLY FOR A WORK VEHICLE

(71) Applicant: CNH Industrial America, LLC, New Holland, PA (US)

(72) Inventor: Duqiang WU, Bolingbrook, IL (US)

(73) Assignee: CNH Industrial America, LLC

(21) Appl. No.: 15/838,588

(22) Filed: Dec. 12, 2017

(51) Int. Cl. E02F 3/43; E02F 3/358; E02F 3/34

(52) U.S. Cl. CPC E02F 3/431; E02F 3/358; B66F 9/0755; E02F 3/3402; E02F 3/3405

(57) ABSTRACT

In one aspect, an implement adjustment assembly may include a lift arm pivotably coupled to a frame of a work vehicle at a first pivot joint and a bell crank pivotably coupled to the lift arm. Furthermore, the implement adjustment assembly may include a first actuator pivotably coupled to the frame of the work vehicle at a second pivot joint, with the first actuator further being pivotably coupled to the bell crank. The second pivot joint may be spaced apart from the first pivot joint by a first distance along a vertical direction of the work vehicle and by a second distance along a longitudinal direction of the work vehicle, with the first distance being at least one and half times greater than the second distance.

### FIELD

The present disclosure generally relates to work vehicles and, more particularly, to implement adjustment assemblies configured to adjust a position and/or orientation of an implement of a work vehicle.

### BACKGROUND

It is well known that, in the construction of many buildings, bridges, roads, and/or the like, that the topography of the soil must be manipulated, typically through the use of an earthmoving operation. Earthmoving operations are generally performed by a work vehicle, such as a wheel loader, that includes an implement, such as a bucket, configured to move a volume of soil between various locations. In order to move the soil, the work vehicle includes an implement adjustment assembly configured to lift or otherwise move the implement between a lowered position and a raised position. For example, the implement is typically able to receive the volume of soil from the ground when at the lowered position. Conversely, the work vehicle is generally able to transport the volume of soil between locations when the implement is at the raised position. To facilitate such movement between the raised and lowered positions, the implement adjustment assembly typically includes various actuators, arms, links, and pivot joints.

In certain instances, it is desirable that the implement remain parallel to the ground when being moved between the raised and lowered positions. However, the relative positioning of the pivot joints of conventional implement adjustment assemblies requires simultaneous manipulation of multiple actuators to maintain the implement at an orientation that is parallel to the ground when being moved between the raised and lowered positions. Such simultaneous manipulation of multiple actuators requires a skilled and experienced operator to safely perform.

Accordingly, an improved implement adjustment assembly for a work vehicle would be welcomed in the technology.

### BRIEF DESCRIPTION

Aspects and advantages of the technology will be set forth in part in the following description, or may be obvious from the description, or may be learned through practice of the technology.

In one aspect, the present subject matter is directed to an implement adjustment assembly for a work vehicle. The work vehicle may include a frame extending in a longitudinal direction between a forward end of the work vehicle and an aft end of the work vehicle. The work vehicle may further extend in a vertical direction between a top end of the work vehicle and a bottom end of the work vehicle. The implement adjustment assembly may include a lift arm pivotably coupled to the frame at a first pivot joint and a bell crank pivotably coupled to the lift arm. Furthermore, the implement adjustment assembly may include a first actuator pivotably coupled to the frame at a second pivot joint, with the first actuator further being pivotably coupled to the bell crank. The second pivot joint may be spaced apart from the first pivot joint by a first distance along the vertical direction and by a second distance along the longitudinal direction, with the first distance being at least one and half times greater than the second distance.

In another aspect, the present subject matter is directed to an implement adjustment assembly for a work vehicle. The work vehicle may include a frame extending along a longitudinal direction between a forward end of the work vehicle and an aft end of the work vehicle. The work vehicle may further extend along a vertical direction from a top end of the work vehicle to a bottom end of the work vehicle. The implement adjustment assembly may include a frame and a lift arm pivotably coupled to the frame at a first pivot joint and an implement pivotably coupled to the lift arm. The implement adjustment assembly may also include a bell crank pivotably coupled to the lift arm and a link pivotably coupled to the bell crank and the implement. Furthermore, the implement adjustment assembly may include a first actuator pivotably coupled to the frame at a second pivot joint, with the first actuator further being pivotably coupled to the first end of the bell crank. Moreover, the implement adjustment assembly may include a second actuator pivotably coupled to the frame at a third pivot joint, with the second actuator further being pivotably coupled to the lift arm. Additionally, the second pivot joint may be spaced apart from the first pivot joint by a first distance along the vertical direction and by a second distance along the longitudinal direction. Furthermore, the second pivot joint may be spaced apart from the third pivot joint by a third distance along the vertical direction and by a fourth distance along the longitudinal direction. Moreover, the first distance may be at least one and half times greater than the second distance, and the third distance may at least one and half times greater than the fourth distance.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a side view of one embodiment of a work vehicle in accordance with aspects of the present subject matter, particularly illustrating an implement of the work vehicle at a lowered position relative to a ground surface;

FIG. 2 illustrates another side view of the work vehicle shown in FIG. 1 in accordance with aspects of the present subject matter, particularly illustrating the implement of the work vehicle at a raised position relative to the ground surface;

FIG. 3 illustrates a side view of a one embodiment of an implement adjustment assembly in accordance with aspects of the present subject matter; and

FIG. 4 illustrates an enlarged side view of a portion of the implement adjustment assembly shown in FIG. 3, particularly illustrating the relative positioning between various pivot joints of the implement adjustment assembly.

Repeat use of reference characters in the present specification and drawings is intended to represent the same or analogous features or elements of the present technology.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to an implement adjustment assembly for a work vehicle. Specifically, in several embodiments, the implement adjustment assembly may include a lift arm pivotably coupled to a frame of the work vehicle at a first pivot joint. The lift arm may also be pivotably coupled to an implement, such as a bucket, of the work vehicle. The implement adjustment assembly may also include a bell crank pivotably coupled to the lift arm and the implement. Furthermore, the implement adjustment assembly may include an actuator pivotably coupled to the frame at a second pivot joint. The actuator may also be pivotably coupled to the bell crank such that the actuator may be configured to pivot the implement relative to the lift arm so as to control the orientation of the implement relative to a ground surface.

In accordance with aspects of the present subject matter, the second pivot joint may be spaced apart from the first pivot joint by a first distance along a vertical direction of the work vehicle and by a second distance along a longitudinal direction of the work vehicle, with the first distance being at least one and half times greater than the second distance. Such relative positioning between the first and second pivot joints may orient various components of the implement adjustment assembly in such a manner that the implement remains parallel to the ground surface as the implement is being moved relative to the ground surface along the vertical direction, such as between a lowered position and a raised position.

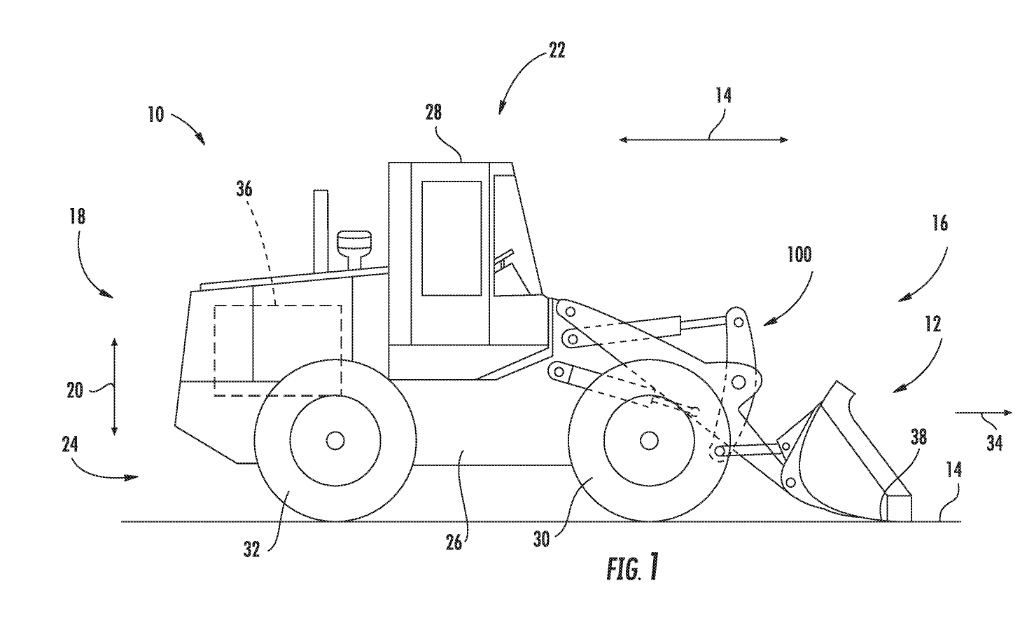

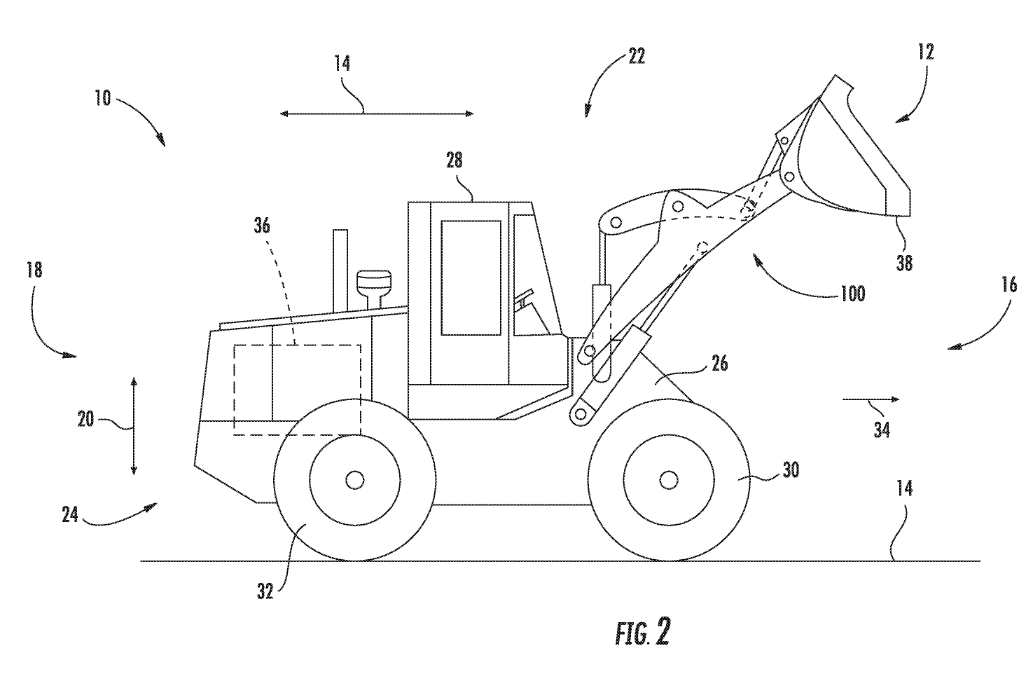

Referring now to the drawings, FIGS. 1 and 2 illustrate differing side views of one embodiment of a work vehicle 10. Specifically, FIG. 1 illustrates a side view of the work vehicle 10 with an implement 12 of the work vehicle 10 at a lowered position relative to a ground surface 14. Additionally, FIG. 2 illustrates a side view of the work vehicle 10 with the implement 12 at a raised position relative to the ground surface 14.

As shown, the work vehicle 10 may be configured as a wheel loader. However, in other embodiments, the work vehicle 10 may be configured as any other suitable work vehicle known in the art, including those for agricultural and construction applications, transport, sport, and/or the like. In general, the work vehicle 10 may extend longitudinally (e.g., as indicated by arrow 14 in FIGS. 1 and 2) between a forward end 16 of the work vehicle 10 and an aft end 18 of the work vehicle 10. In addition, the work vehicle 10 may also extend vertically (e.g., as indicated by arrow 20 in FIGS. 1 and 2) between a top end 22 of the work vehicle 10 and a bottom end 24 of the work vehicle 10.

The work vehicle 10 may include a frame or chassis 26 that is configured to support or couple to a plurality of components. For example, as will be described below, in several embodiments, the frame 26 may be configured to support the implement 12 at the forward end 16 of the work vehicle 10. The frame 26 may also be configured to support an enclosed operator's cab 28 at a location positioned centrally between the forward and aft ends 16, 18 of the work vehicle 10. Furthermore, in one embodiment, a pair of steerable front wheels 30 and a pair of driven, ground-engaging rear wheels 32 may be coupled to the frame 26. The wheels 30, 32 may be configured to support the work vehicle 10 relative to the ground surface 14 and move the work vehicle 10 in a forward direction of travel 34 relative to the ground surface 14. Additionally, as is generally understood, the work vehicle 10 may include an engine 36 and a transmission (not shown) supported by the frame 26. The transmission may be operably coupled to the engine 36 and may provide variably adjusted gear ratios for transferring engine power to the wheels 32 via a drive axle assembly (or via axles if multiple drive axles are employed).

In accordance with aspects of the present disclosure, the implement 12 of the work vehicle 10 may be configured to transport or otherwise convey a volume of soil or other material (e.g., building materials and debris) relative to the ground surface 14. As shown, the implement 12 may be configured as a bucket. In several embodiments, the implement 12 may be adjustably mounted to the frame 24 so as to lift the volume of soil along the vertical direction 20 relative to the ground surface 14. Specifically, as shown, the implement 12 may be moveable between a lowered position relative to the ground surface 14 as shown in FIG. 1 and a raised position relative to the ground surface 14 as shown in FIG. 2. For example, in one embodiment, a bottom surface 38 of the implement 12 may in contact with or proximate to the ground surface 14 when the implement 12 is at the lowered position. Conversely, when the implement 12 is at the raised position, the bottom surface 38 of the implement 12 is positioned above the ground surface 14 along the vertical direction 20, such as at a position proximate to the top end 22 of the work vehicle 10. However, in alternative embodiments, the raised and lowered positions may correspond to any other suitable positions along the travel path of the implement 12, with the raised position being located above the lowered position in the vertical direction 20. Furthermore, as will be described below, an implement adjustment assembly 100 may be configured to adjustably couple the implement 12 to the frame 26 and move the implement 12 along the vertical direction 20, such as between the lowered and raised positions. It should be appreciated that, in other embodiments, the implement 12 may be configured as any other suitable type of implement, such as a blade or forks.

It should also be appreciated that the configuration of the work vehicle 10 described above and shown in FIGS. 1 and 2 is provided only to place the present subject matter in an exemplary field of use. Thus, it should be apparent that the present subject matter may be readily adaptable to any manner of work vehicle configuration. For example, in an alternative embodiment, the work vehicle 10 may include an open operator's cab 28.

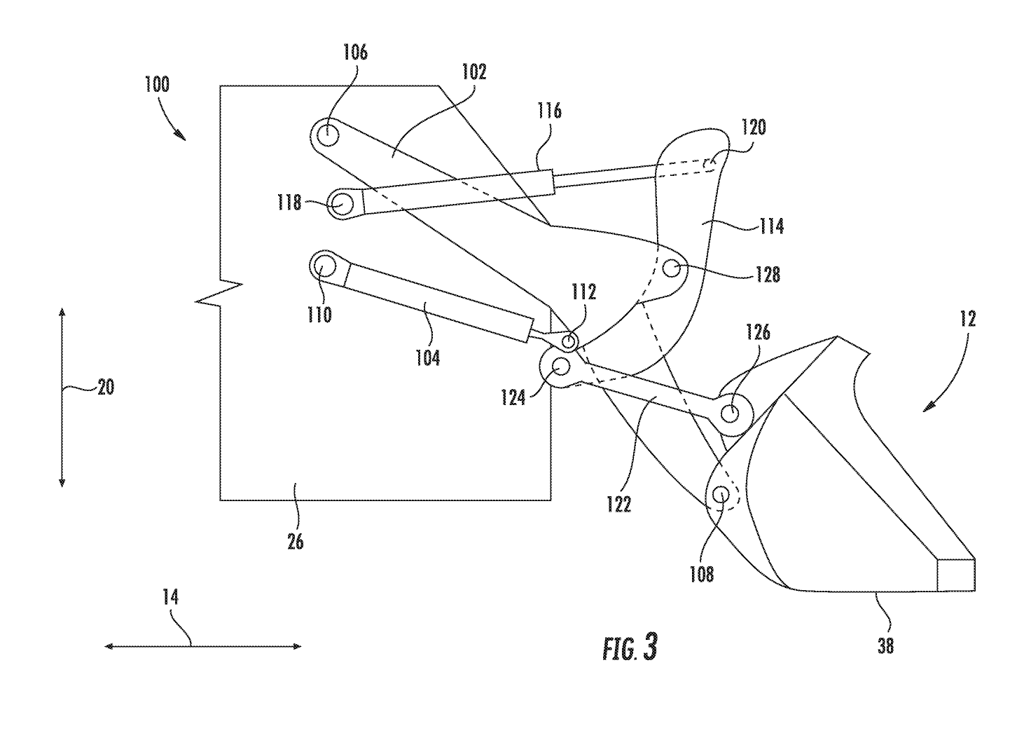

Referring now to FIG. 3, a side view of one embodiment of an implement adjustment assembly 100 suitable for use with a work vehicle is illustrated in accordance with aspects of the present subject matter. In general, the implement adjustment assembly 100 will be described herein with reference to the work vehicle 10 described above with reference to FIGS. 1 and 2. However, it should be appreciated by those of ordinary skill in the art that the disclosed implement adjustment assembly 100 may generally be utilized with work vehicles having any other suitable vehicle configuration.

In several embodiments, the implement adjustment assembly 100 may include a lift arm 102 and an associated arm actuator 104. In one embodiment, one end of the lift arm 102 may be pivotably coupled to the frame 26 of the work vehicle 10 at a first arm pivot joint 106. Similarly, an opposed end of the lift arm 102 may be coupled to the implement 12 of the work vehicle 10 at a second arm pivot joint 108. Furthermore, one end of the arm actuator 104 may be pivotably coupled to the frame 26 of the work vehicle 10 at a first arm actuator pivot joint 110. Similarly, an opposed end of the arm actuator 104 may be coupled to the lift arm 102 at a second arm actuator pivot joint 112. As shown, the second arm actuator pivot joint 112 may be positioned at a location on the lift arm 102 between the first and second arm pivot joints 106, 108. As such, the arm pivot joints 106, 110, 112 may allow relative pivotable movement between the frame 26, the lift arm 102, and the arm actuator 104, thereby allowing the position of the implement 12 relative to the ground surface 14 to be adjusted along the vertical direction 20. For example, the arm actuator 104 may be configured move the implement 12 along the vertical direction 20 between the lowered position (FIG. 1) and the raised position (FIG. 2). However, a person of ordinary skill in the art would appreciate that the implement 12 may be adjustably coupled to the frame 26 in any suitable manner that permits the actuator arm 104 to move the implement 12 along the vertical direction 20 relative to the ground surface 14.

The implement adjustment assembly 100 may also include a bell crank 114 and an associated crank actuator 116. Specifically, as shown, one end of the crank actuator 116 may be pivotably coupled to the frame 26 of the work vehicle 10 at a first crank actuator pivot joint 118. Similarly, an opposed end of the crank actuator 116 may be coupled to one end of the bell crank 114 at a second crank actuator pivot joint 120. In an alternative embodiment, a link (not shown) may be coupled between the crank actuator 116 and the bell crank 114. Furthermore, an opposed end of the bell crank 114 may be pivotably coupled to one end of a link 122 at a first link pivot joint 124. An opposed end of the link 122 may, in turn, be pivotably coupled to the implement 12 at a second link pivot joint 126. Additionally, a central portion of the bell crank 114 (e.g., a portion located between the pivot joints 120, 124) may be pivotably coupled to a central portion of the lift arm 102 (e.g., a portion located between the arm pivot joints 106, 108) at a crank pivot joint 128. As such, the pivot joints 118, 120, 124, 126 may allow relative pivotable movement between the frame 26, the crank actuator 116, the bell crank 114, and the link 122, thereby allowing the angular orientation of the implement 12 to be adjusted relative to the ground surface 14. In this regard, the crank actuator 116 may be configured pivot or rotate the implement 12 between various angles defined between the bottom surface 38 of the implement 12 and the ground surface 14. For example, in certain instances, the crank actuator 116 may be configured to orient the implement 12 such that the bottom surface 38 of the implement 12 is parallel to the ground surface 14 as shown in FIGS. 1-3. However, a person of ordinary skill in the art would appreciate that the implement 12 may be adjustably coupled to the frame 26 in any suitable manner that permits the crank actuator 116 to rotate the implement 12 between various angular orientations relative to the ground surface 14.

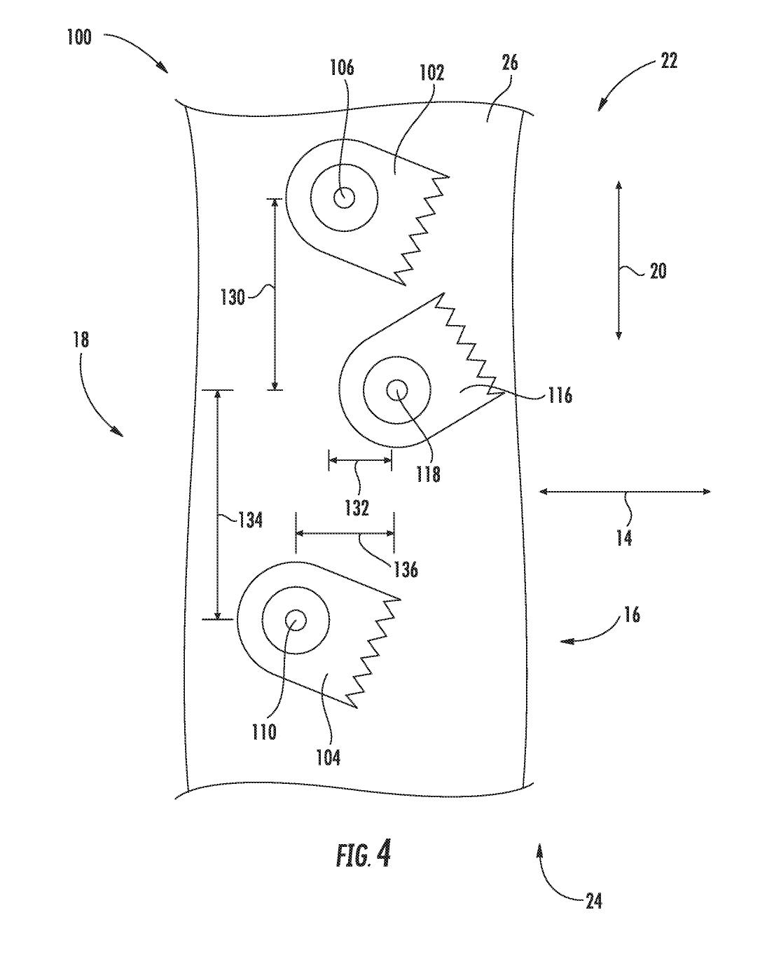

Referring now to FIG. 4, one embodiment of the relative positioning between the pivot joints 106, 110, and 118 defined between the components of the implement adjustment assembly 100 and the frame 12 of the work vehicle 10 is illustrated in accordance with aspects of the present disclosure. As shown, in several embodiments, the first crank actuator pivot joint 118 (i.e., defined between the crank actuator 116 and the frame 26) may be positioned below the first arm pivot joint 106 (i.e., defined between the lift arm 102 and the frame 26) along the vertical direction 20 of the work vehicle. In this regard, the pivot joints 106, 118 may, in one embodiment, be spaced apart a first vertical distance 130 defined between the center points of the pivot joints 108, 118 along the vertical direction 20 of the work vehicle 10. Furthermore, in several embodiments, the first crank actuator pivot joint 118 may be positioned forward of the first arm pivot joint 106 along the longitudinal direction 14 of the work vehicle 10. In this regard, the pivot joints 106, 118 may, in one embodiment be spaced apart a first horizontal distance 132 defined between the center points of the pivot joints 106, 118 along the longitudinal direction 14 of the work vehicle 10. In several embodiments, the first vertical distance 130 may be at least one and half times greater than the first horizontal distance 132. For example, in one embodiment, the first vertical distance 130 may be at least twice as great as the first horizontal distance 132. In another embodiment, the first vertical distance 130 may be at least two and a half times as great as the first horizontal distance 132. In a further embodiment, the first vertical distance 130 may be at least three times as great as the first horizontal distance 132. In an additional embodiment, the first vertical distance 130 may be at least three and half times as great as the first horizontal distance 132. In yet a further embodiment, the first vertical distance 130 may be at least four times as great as the first horizontal distance 132.

In general, a person of ordinary skill the art would appreciate that the first vertical and first horizontal distances 130, 132 may be any other suitable distances so long as the first vertical distance 130 is at least one and a half times as great as the first horizontal distance 132. For example, in one embodiment, the first vertical distance 130 may be approximately three hundred and thirty millimeters and the first horizontal distance 132 may be approximately seventy-five millimeters. In another embodiment, the first vertical distance 130 may be approximately three hundred and sixty-five millimeters and the first horizontal distance 132 may be approximately one hundred and fifty millimeters. In a further embodiment, the first vertical distance 130 may be approximately three hundred and eighty millimeters and the first horizontal distance 132 may be approximately one hundred millimeters.

Additionally, the relationship between the first vertical distance 130 and the first horizontal distance 132 may be based on the size of the work vehicle 10. For example, in one embodiment, the first vertical distance 130 may be at least four times as great as the first horizontal distance 132 on a small or light-duty work vehicle 10. Furthermore, the first vertical distance 130 may be at least three times, such as between three times and four times, as great as the first horizontal distance 132 on a medium-sized or medium duty work vehicle 10. Moreover, the first vertical distance 130 may be at least one and half times, such as between one and half times and three times, as great as the first horizontal distance 132 on a large or heavy-duty work vehicle 10. However, a person of ordinary skill in the art would appreciate that the first vertical and first horizontal distances 130, 132 may be any other suitable relationships regardless of the size of the work vehicle 10 so long as the first vertical distance 130 is at least one and a half times as great as the first horizontal distance 132.

Moreover, as shown in FIG. 4, in one embodiment, the first crank actuator pivot joint 118 (i.e., defined between the crank actuator 116 and the frame 26) may be positioned above the first arm actuator pivot joint 110 (i.e., defined between the arm actuator 104 and the frame 26) along the vertical direction 20 of the work vehicle. In this regard, the pivot joints 106, 118 may, in one embodiment, be spaced apart a second vertical distance 134 defined between the center points of the pivot joints 110, 118 along the vertical direction 20 of the work vehicle 10. Additionally, in several embodiments, the first crank actuator pivot joint 118 may be positioned forward of the first arm actuator pivot joint 110 along the longitudinal direction 14 of the work vehicle 10. In this regard, the pivot joints 110, 118 may, in one embodiment, be spaced apart a second horizontal distance 136 defined between the center points of the pivot joints 110, 118 along the longitudinal direction 14 of the work vehicle 10. In several embodiments, the second vertical distance 134 may be at least one and half times greater than the second horizontal distance 136. For example, in one embodiment, the second vertical distance 134 may be at least twice as great as the second horizontal distance 136. In another embodiment, the second vertical distance 134 may be at least two and a half times as great as the second horizontal distance 136. In a further embodiment, the second vertical distance 134 may be at least three times as great as the second horizontal distance 136. In an additional embodiment, the second vertical distance 134 may be at least three and half times as great as the second horizontal distance 136. In yet a further embodiment, the second vertical distance 134 may be at least four times as great as the second horizontal distance 136. Furthermore, in one embodiment, the first crank actuator pivot joint 118 may be positioned closer to the first arm actuator pivot joint 110 along the vertical direction 20 than the first arm actuator pivot joint 106. However, in alternative embodiments, the first crank actuator pivot joint 118 may be positioned the same distance or farther away from the first arm actuator pivot joint 110 along the vertical direction 20 than the first arm actuator pivot joint 106.

As described above, the actuators 104, 116 may be configured to adjust differing aspects of the implement 12 relative to the ground. Specifically, the arm actuator 104 may be configured to adjust the relative distance between the bottom surface 38 of the implement 12 and the ground surface 14 along the vertical direction 20 of the work vehicle 10, while the crank actuator 116 may be configured to adjust the angular orientation of the bottom surface 38 of the implement 12 relative the ground surface 14. In this regard, the actuators 104, 116 may be independently controlled, such as via two different levers or other user input devices (not shown). As such, an operator of the work vehicle 10 may be able to adjust the relative distance between the bottom surface 38 of the implement 12 and the ground surface 14 along the vertical direction 20 by controlling the arm actuator 104 without changing the angular orientation of the bottom surface 38 of the implement 12 relative the ground surface 14. Similarly, the operator may also be able to adjust the angular orientation of the bottom surface 38 of the implement 12 relative the ground surface 14 by controlling the crank actuator 116 without changing the relative distance between the bottom surface 38 of the implement 12 and the ground surface 14 along the vertical direction 20. However, in alternative embodiments, the actuators 104, 116 may be controlled simultaneously or otherwise together or as a single unit. Furthermore, although the actuators 104, 116 are illustrated as fluid-driven actuators (e.g., hydraulic or pneumatic cylinders) in FIGS. 1-3, it should be appreciated that, in alternative embodiments, the actuators 104, 116 may correspond to any suitable type of actuators, such as electric linear actuators.

In several embodiments, the angular orientation of the bottom surface 38 of the implement 12 may remain constant as the implement 12 is moved along the vertical direction 20. More specifically, as described above, the first crank actuator pivot joint 118 (i.e., defined between the crank actuator 116 and the frame 26) may generally be positioned below and forward of the first arm pivot joint 106 (i.e., defined between the lift arm 102 and the frame 26) such that the vertical distance 130 between the pivot joints 106, 118 is at least one and half times greater than the longitudinal distance 132 therebetween. Such relative positioning between the pivot joints 106, 108 orients the various components of the implement adjustment assembly 100 in such a manner that the angular orientation of the bottom surface 38 of the implement 12 relative to the ground surface 14 remains constant as the implement 12 is moved along the vertical direction 20 by the arm actuator 104, such as between the lowered position (FIG. 1) and the raised position (FIG. 2). Furthermore, this angular orientation of the implement 12 may be maintained during such vertical movement without any input from or adjustment of the bell crank 114 by the crank actuator 116. For example, after the bottom surface 38 of the implement 12 has been oriented parallel to the ground surface 14 (e.g., via the crank actuator 116), the implement 12 may be moved along the vertical direction 20, such as between the lowered position and the raised position, by the arm actuator 104. Throughout this vertical movement, the bottom surface 38 of the implement 12 remains oriented parallel to the ground surface 14 without any adjustment of the bell crank 114 from the crank actuator 116.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An implement adjustment assembly for a work vehicle, the work vehicle including a frame extending in a longitudinal direction between a forward end of the work vehicle and an aft end of the work vehicle, the work vehicle further extending in a vertical direction between a top end of the work vehicle and a bottom end of the work vehicle, the implement adjustment assembly comprising:
a lift arm pivotably coupled to the frame at a first pivot joint;
a bell crank pivotably coupled to the lift arm; and
a first actuator pivotably coupled to the frame at a second pivot joint, the first actuator further being pivotably coupled to the bell crank;
wherein the second pivot joint is spaced apart from the first pivot joint by a first distance along the vertical direction and by a second distance along the longitudinal direction, the first distance being at least one and half times greater than the second distance.

2. The implement adjustment assembly of claim 1, wherein the first distance is at least two times greater than the second distance.

3. The implement adjustment assembly of claim 1, wherein the first distance is at least two and a half times greater than the second distance.

4. The implement adjustment assembly of claim 1, wherein the first distance is at least three times greater than the second distance.

5. The implement adjustment assembly of claim 1, wherein the second pivot joint is positioned below the first pivot joint along the vertical direction.

6. The implement adjustment assembly of claim 1, further comprising:
a second actuator pivotably coupled to the frame at a third pivot joint, the second actuator further being pivotably coupled to the lift arm, wherein the second pivot joint is spaced apart from the third pivot joint by a third distance along the vertical direction and by a fourth distance along the longitudinal direction, the third distance being at least one and half times greater than the fourth distance.

7. The implement adjustment assembly of claim 6, wherein the third distance is at least two times greater than the fourth distance.

8. The implement adjustment assembly of claim 6, wherein the third distance is at least two and a half times greater than the fourth distance.

9. The implement adjustment assembly of claim 6, wherein the third distance is at least three times greater than the fourth distance.

10. The implement adjustment assembly of claim 6, wherein the second pivot joint is positioned closer to the third pivot joint along the vertical direction than the first pivot joint.

11. An implement adjustment assembly for a work vehicle, the work vehicle include a frame extending in a longitudinal direction between a forward end of the work vehicle and an aft end of the work vehicle, the work vehicle further extending in a vertical direction between a top end of the work vehicle and a bottom end of the work vehicle, the implement adjustment assembly comprising:
a frame;
a lift arm pivotably coupled to the frame at a first pivot joint;
an implement pivotably coupled to the lift arm;
a bell crank pivotably coupled to the lift arm;
a link pivotably coupled to the bell crank and the implement;
a first actuator pivotably coupled to the frame at a second pivot joint, the first actuator further being pivotably coupled to the bell crank; and
a second actuator pivotably coupled to the frame at a third pivot joint, the second actuator further being pivotably coupled to the lift arm,
wherein the second pivot joint is spaced apart from the first pivot joint by a first distance along the vertical direction and by a second distance along the longitudinal direction, the second pivot joint is spaced apart from the third pivot joint by a third distance along the vertical direction and by a fourth distance along the longitudinal direction, the first distance being at least one and half times greater than the second distance, the third distance being at least one and half times greater than the fourth distance.

12. The implement adjustment assembly of claim 11, wherein the first distance is at least two times greater than the second distance.

13. The implement adjustment assembly of claim 11, wherein the first distance is at least two and a half times greater than the second distance.

14. The implement adjustment assembly of claim 11, wherein the first distance is at least three times greater than the second distance.

15. The implement adjustment assembly of claim 11, wherein the second pivot joint is positioned below the first pivot joint along the vertical direction.

16. The implement adjustment assembly of claim 11, wherein the third distance is at least two times greater than the fourth distance.

17. The implement adjustment assembly of claim 11, wherein the third distance is at least two and a half times greater than the fourth distance.

18. The implement adjustment assembly of claim 11, wherein the second pivot joint is positioned closer to the third pivot joint along the vertical direction than the first pivot joint.

19. The implement adjustment assembly of claim 11, wherein the implement comprises a bucket.

20. The implement adjustment assembly of claim 11, wherein the implement remains parallel to a ground surface when the second actuator moves the implement between a first position and a second position, the first position being below the second position along the vertical direction.
